(19) United States
(12) Patent Application Publication
(10) Pub. No.: US 2002/0088760 A1
(43) Pub. Date: Jul. 11, 2002

(54) Method and apparatus for dispensing a liquid containing specified level of a solute

(76) Inventor: Fred Beatty, Langley (CA)

Correspondence Address: NORMAN M. CAMERON, SUITE 1401 - 1166 ALBERNI STREET, VANCOUVER, BC, V6E 3Z3, CA

(21) Appl. No.: 09/756,132

(22) Filed: Jan. 9, 2001

(51) Int. Cl. C02F 1/70

(52) U.S. Cl. 210/749

(57) ABSTRACT

A liquid dispensing apparatus and method ensure that a liquid dispensed contains a specified level of a first solute. A solution is formed by dissolving a solid in the liquid. There is an inlet for the liquid and an outlet for dispensing the liquid. A mixing chamber is provided for a concentrated solution of the second solute. A metering device meters the concentrated solution from the chamber into another body of the liquid upstream of the outlet to form the liquid containing the specified level of the first solute. A member in the chamber receives the solid. There is a regulator for regulating output of the liquid from the apparatus. An actuator operatively connects the member the regulator. Solid on the member opens the regulator to allow the liquid to be dispensed from the apparatus. When the solid is depleted, the regulator is closed to prevent the liquid from being dispensed.

### BACKGROUND OF THE INVENTION

This invention relates to apparatuses for dispensing liquids containing specified levels of a solute. In particular, the invention relates to apparatuses for dispensing dechlorinated water.

The need sometimes arises for an apparatus and method to dispense a liquid containing specified levels of a solute. For example, such an apparatus and method are desirable for dispensing dechlorinated water. The need for such an apparatus and method occurs, for example, during street flushing operations. Most municipal water systems supply chlorinated water. The chlorine is added to reduce the levels of bacteria and other potentially harmful organisms. However, a problem arises when this water is used for other purposes such as street cleaning or flushing.

The water from street cleaning, or flushing, drains into the storm sewer system in most municipalities. Often the water is discharged into creeks, streams and rivers which may provide a suitable habitat for fish and other aquatic life. If chlorine is added to the water, this can kill or harm such aquatic life.

Accordingly, it is desirable to dechlorinate water before using it for street flushing or cleaning. It is also desirable to dechlorinate water under other circumstances such as during the draining of swimming pools. This water also can prove harmful if discharged into a storm sewer system.

One common method of dechlorinating water is to add sodium thiosulfate to chlorinated water. It has the effect of reducing chlorine levels. Often containers of solid sodium thiosulfate are added to water tanks on street cleaning or flushing units. The sodium thiosulfate continues to dechlorinate water as water is added to replenish the tank. However, once the solid sodium thiosulfate is used up, the water is no longer dechlorinated. Sometimes this occurs by inadvertence. The operator of the street flushing or cleaning unit may not be aware that the sodium thiosulfate has been consumed. As a result, chlorinated water is accidentally discharged into the environment.

Accordingly, it is an object of the invention to provide an improved apparatus and method for dispensing a solution containing a specified level of a solute.

More particularly, is an object of the invention to provide an improved apparatus and method for dispensing water containing specified maximum levels of chlorine.

It is also in object of the invention to provide a method and apparatus for dispensing water which has been properly dechlorinated.

Is a further object of the invention to provide an improved apparatus and method for dechlorinating water whereby discharge of water is stopped if a dechlorinating chemical is depleted.

It is a still further object of the invention to provide an improved apparatus and method for dechlorinating water which is simple and reliable in construction and operation.

### BACKGROUND OF THE INVENTION

There is provided, according to one aspect of the invention, a liquid dispensing apparatus which ensures that a liquid dispensed from the apparatus contains specified levels of a first solute. A solution of a second solute is formed by dissolving a solid in the liquid. The solution of the second solute is reactive with the first solute to alter the level of the first solute. The apparatus has an inlet for the liquid, an outlet for dispensing the liquid and comprises a mixing chamber for a concentrated solution of the second solute. There is a metering device for metering the concentrated solution from the chamber into another body of the liquid upstream of the outlet to form the solution containing the specified level of the first solute. A member in the chamber receives the solid. A regulator regulates output of the liquid from the apparatus. An actuator operatively connects the member to the regulator. The solid on the member opens the regulator to allow the liquid to be dispensed from the apparatus. When the solid is depleted, the regulator is closed to prevent the liquid from being dispensed from the apparatus.

There is provided, according to another aspect of the invention, a water dechlorinating apparatus which ensures that water dispensed by the apparatus contains a specified level of chlorine. The water is dechlorinated by dissolving a solid reactive with chlorine in the water. The apparatus has an inlet for chlorinated water, and an outlet for dispensing dechlorinated water. There is a mixing chamber for a concentrated solution of the solute. A metering device meters the concentrated solution from the chamber into another body of the water upstream of the outlet to form the solution containing the specified level of chlorine. A member in the chamber receives the solid. A regulator regulates output of dechlorinated water from the apparatus. An actuator operatively connects the member to the regulator. Solid on the member opens the regulator to allow the dechlorinated water to be dispensed from the apparatus. When the solid is depleted, the regulator is closed to prevent chlorinated water from being dispensed from the apparatus.

There is provided, according to a further aspect of the invention, a method for controlling the dispensing of a liquid from an apparatus such that the liquid is dispensed only when a solid solute remains in the apparatus. The method includes placing the solid solute on a movable platform to depress the platform. The platform is operatively connected to a regulator which controls output of the liquid. Dispensing of the liquid is permitted when the solid rests on the platform and is stopped when the solid is depleted and the platform is allowed to rise.

### BRIEF DESCRIPTION OF THE DRAWINGS

FIG. 1 is a top plan view, partly diagrammatic, of an apparatus for dechlorinating water according to an embodiment of the invention; and

FIG. 2 is a side, sectional view thereof.

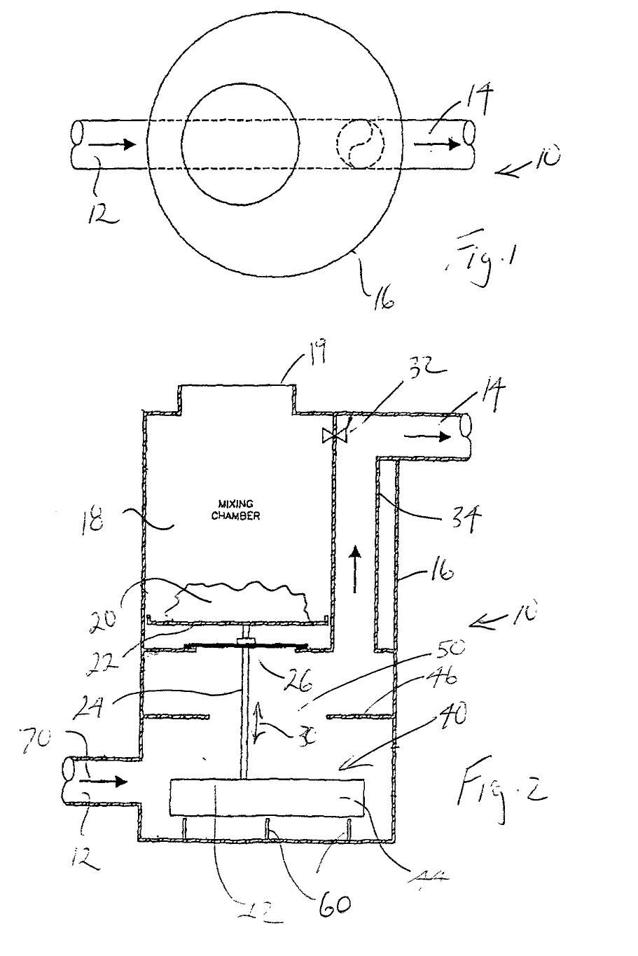

### DETAILED DESCRIPTION OF THE PREFERRED EMBODIMENTS

Referring to the drawings, these show an apparatus 10 for dechlorinating chlorinated water. It should be understood however that the invention is also applicable to other apparatuses and methods which ensure that a solution dispensed contains a specified level of a solute and where a solution is formed by dissolving a solid in a liquid. In this example chlorine is the first solute in the liquid which is water.

The apparatus includes an inlet 12 for chlorinated water and an outlet 14 for dispensing dechlorinated water. The apparatus includes a tank-like body 16 which includes a mixing chamber 18 which is closed apart from access opening 19 on top, orifice 32 described below and about bushing 26 described below. The mixing chamber contains a concentrated solution of a second solute, sodium thiosulfate in this example. Solid sodium thiosulfate 20 is placed on a vertically movable platform or member 22 within the mixing chamber. The platform is movably supported by an actuator or rod 24 which extends slidably through a bushing 26 at the bottom of the chamber to allow vertical movement as indicated by arrows 30. Orifice 32 on the mixing chamber meters the flow of sodium thiosulfate from the mixing chamber into a passageway 34 upstream of outlet 14.

The apparatus includes a regulator 40 which is located within an inlet chamber 42 adjacent inlet 12 in this example. The regulator includes a float member 44 which is connected to the rod 24 at the lower end thereof in this example. There is a bulkhead 46 forming the top of the inlet chamber which has an opening 50 therein. When the sodium thiosulfate 20 rests on the platform 22, the weight thereof counteracts the buoyancy of float member 44, keeping it in the lower position shown in FIG. 2 against rests 60. Chlorinated water entering the unit, illustrated by arrow 70, flows through the inlet chamber 42, out through opening 50 and into passageway 34 where it bypasses mixing chamber 18. Some water can enter the mixing chamber through the space between rod 24 and bushing 26 to dissolve the sodium thiosulfate 20 which thereby forms a second solute in the water. A concentrated solution of sodium thiosulfate exits the mixing chamber through orifice 32 to dechlorinate the water in passageway 34 before it is discharged from outlet 14.

Eventually the sodium thiosulfate 20 is completely dissolved within the mixing chamber and the weight of this chemical is removed from platform 22. Thus the weight of the sodium thiosulfate no longer counteracts the buoyancy of float 22. The float therefore rises until it contacts bulkhead 46 and seals opening 50. Water can no longer flow into the passageway 34 and accordingly is no longer discharged from outlet 14. Since the sodium thiosulfate has been depleted, such water would not be properly dechlorinated. Thus the apparatus insures that chlorinated water is not inadvertently discharged from the unit into the environment.

It will be understood by someone skilled in the art of many of the details provided are by way of example only and are not intended to limit the scope of the invention which is to be interpreted with reference to the following claims.

What is claimed is:

1. A liquid dispensing apparatus which ensures that a liquid dispensed from the apparatus contains a specified level of a first solute, a solution of a second solute being formed by dissolving a solid in the liquid, the solution of the second solute being reactive with the first solute to alter the level of the first solute, the apparatus having an inlet for the liquid, an outlet for dispensing the liquid and comprising:
a mixing chamber for a concentrated solution of the second solute, a metering device for metering the concentrated solution from the chamber into another body of said liquid upstream of the outlet to form said solution containing the specified level of the first solute, a member in the chamber for receiving the solid, a regulator for regulating output of the liquid from the apparatus, an actuator operatively connecting the member to the regulator, whereby the solid on the member opens the regulator to allow the liquid to be dispensed from the apparatus and, when the solid is depleted, the regulator is closed to prevent the liquid from being dispensed from the apparatus.

2. An apparatus as claimed in claim 1, wherein the regulator regulates input of the liquid into the apparatus and thereby regulates output of the liquid from the apparatus

3. An apparatus as claimed in claim 2, wherein the member includes a vertically movable platform in the chamber, the solid on the platform depressing the platform.

4. An apparatus as claimed in claim 3, wherein the regulator includes a valve member with a float, the actuator being connected to the float to depress the float when the solid is located on the platform and thereby open the regulator.

5. An apparatus as claimed in claim 4, including an opening for the liquid above the valve member, whereby, when the solid is depleted, the platform rises and the float thereby rises to block a flow of the liquid through the opening.

6. An apparatus as claimed in claim 5, wherein the actuator includes a rod.

7. An apparatus as claimed in claim 6, including a passageway extending from the opening to the outlet which bypasses the chamber, the metering device communicating with the passageway.

8. An apparatus as claimed in claim 7, including an inlet chamber between the inlet and the opening, the float being located in the inlet chamber.

9. A water dechlorinating apparatus which ensures that water dispensed by the apparatus contains a specified level of chlorine, said water being dechlorinated by dissolving a solid reactive with chlorine in the water, whereby the solid becomes a solute in the water, the apparatus having an inlet for chlorinated water, an outlet for dispensing dechlorinated water and comprising:
a mixing chamber for a concentrated solution of the solute, a metering device for metering the concentrated solution from the chamber into another body of the water upstream of the outlet to dechlorinate the water, a member in the chamber for receiving the solid, a regulator for regulating output of dechlorinated water from the apparatus, an actuator operatively connecting the member to the regulator, whereby the solid on the member opens the regulator to allow the dechlorinated water to be dispensed from the apparatus and, when the solid is depleted, the regulator is closed to prevent chlorinated water from being dispensed from the apparatus.

10. An apparatus as claimed in claim 9, wherein the regulator regulates input of the chlorinated water into the apparatus and thereby regulates output of dechlorinated water from the apparatus

11. An apparatus as claimed in claim 10, wherein the member includes a vertically movable platform in the chamber, the solid on the platform depressing the platform.

12. An apparatus as claimed in claim 11, wherein the regulator includes a valve member with a float, the actuator being connected to the float to depress the float when the solid is located on the platform and thereby open the regulator.

13. An apparatus as claimed in claim 12, including an opening for water above the valve member, whereby, when the solid is depleted, the platform rises and the float thereby rises to block a flow of water through the opening.

14. An apparatus as claimed in claim 13, wherein the actuator includes a rod.

15. An apparatus as claimed in claim 14, including a passageway extending from the opening to the outlet which bypasses the chamber, the metering device communicating with the passageway.

16. An apparatus as claimed in claim 15, including an inlet chamber between the inlet and the opening, the float being located in the inlet chamber.

17. A method for controlling dispensing of a liquid such that the liquid is dispensed only a solid solute remains in the apparatus, the method comprising:
placing the solid solute on a movable platform to depress the platform; and
operatively connecting the platform to a regulator controlling output of the liquid, whereby dispensing of the liquid is permitted when the solid rests on the platform and is stopped when the solid is depleted and the platform is allowed to rise.

18. The method as claimed in claim 17, where the regulator controls input of the liquid and thereby output of the liquid.

19. The method as claimed in claim 18, wherein the regulator includes a float and an opening for the liquid, the platform being operatively connected to the float and the solid solute pressing the float to maintain the float away from the opening and thereby permitting the flow of liquid when the solid is located on the platform.

20. The method as claimed in claim 19, including the step of metering a concentrated solution of the solute into another body of the liquid containing another solute reactive with the solid solute.

21. The method as claimed in claim 20, wherein the solid solute is sodium thiosulfate, the liquid is water and said another solute is chlorine.

22. A liquid dispensing apparatus including a container having a moveable member for receiving a solid solute and a regulator for regulating a flow of liquid from the apparatus, the regulator being operatively connected to the moveable member whereby the flow of liquid is stopped when the solid solute is depleted.
